(19) United States
(12) Patent Application Publication
(10) Pub. No.: US 2013/0031104 A1
(43) Pub. Date: Jan. 31, 2013

(54) RECOMMENDATION JITTER

(71) Applicant: Dinesh Gopinath, Cambridge, MA (US)

(72) Inventor: Dinesh Gopinath, Cambridge, MA (US)

(73) Assignee: ChoiceStream, Inc, Cambridge, MA (US)

(21) Appl. No.: 13/408,228

(22) Filed: Feb. 29, 2012

Related U.S. Application Data
(63) Continuation of application No. 11/968,960, filed on Jan. 3, 2008, now abandoned.
(60) Provisional application No. 60/883,372, filed on Jan. 4, 2007.

(51) Int. Cl. G06F 17/30

(52) U.S. Cl. 707/748; 707/736; 707/E17.033

(57) ABSTRACT

A method for selection of items for one or more users includes performing each of a set of steps to determine the items. Performing the steps includes introducing a controlled variation into a result of each of multiple of the steps. The items for the one or more users are then selected according to the results of the steps.

### CROSS-REFERENCE TO RELATED APPLICATIONS

This application claims the benefit of U.S. Provisional Application No. 60/883,372 filed Jan. 4, 2007, the contents of which are incorporated herein by reference in its entirety.

### BACKGROUND

This invention relates to inducing jitter in recommendation systems.

Automated systems for providing recommendations to consumers have been deployed, for example, in the context of online shopping. In some approaches, recommendations are selected by matching items to a consumer's particular interests. Repeated presentation of the same recommendations may not be effective, for example, if the recommendations do not match the consumer's true interests. In some cases it is preferable to vary the recommendations provided, for example, by selecting items at random. However, some types of random selection may not be conducive to providing a desired experience for the consumer or achieving desired consumer behavior.

### SUMMARY

In one aspect, in general, a method for selection of items for one or more users includes performing each of a set of steps to determine the items. Performing the steps includes introducing a controlled variation into a result of each of multiple of the steps. The items for the one or more users are then selected according to the results of the steps.

Aspects can include one or more of the following features.

Introducing the controlled variation into the result of a step includes limiting variation according to a time span. In some examples, limiting variation according to a time span includes maintaining data used to introduce variation and amending that data at controlled times.

Limiting variation is performed according to at least two different time spans, each associated with a different one of the multiple steps.

Amending the data used to introduce variation includes resetting a random seed used for introducing the controlled variation.

Maintaining the data used to introduce variation includes maintaining data characterizing similarity of items, and amending said data includes introducing random variations into said data.

The multiple steps include at least steps selected from the group consisting of: selection of item domains; formation of a choice set; assigning a score to items in a choice set; ranking items in a choice set; determining similarity of items; selecting items from a choice set for presentation; and presenting scored and/or ranked items of a choice set.

Introducing a controlled variation into a result of each of multiple of the steps includes at least one of: selecting a choice set; perturbing a term of a numerical expression; offsetting a result of evaluation of a numerical expression; and selecting items from a ranked and/or scored list.

Introducing the controlled variation includes selecting the controlled variation according to data characterizing the one or more users. In some examples, selecting the controlled variation includes selecting the variation according to a history for a user.

In another aspect, software stored on computer readable media includes instructions for causing a computing system to perform each of a set of steps to determine a selection of items for one or more users, including introducing a controlled variation into a result of each of multiple of the steps, and to select the items for the one or more users according to the results of the steps.

In another aspect, in general, a system for selection of items for one or more users includes a set of processing modules, each of multiple of the modules being configured to introduce a controlled variation into an output of that module. The modules are coupled to provide the selection of the items according to the outputs of the modules.

In another aspect, in general, a recommendation system introduces “jitter” into automated recommendations. For example, the jitter results in variation in the recommendations made to a particular user. This variation may avoid presenting the same or otherwise redundant or “stale” recommendations to a user.

Aspects can include one or more of the following features.

Jitter is introduced by randomly varying a user's estimated preference parameters that are used to make a recommendation.

Jitter is introduced by adding a random variation in score of items before ranking them.

The amount of random variation to add into scores and/or preference parameters can depend on a range (or other statistic of variation) of the scores and/or parameters over users and/or items.

Jitter is introduced by permuting a rank ordering of items for a user, for example, by rotating a list of top-scoring items.

Jitter is introduced by making a random selection from an ordered set of items. For example, a selection probability for each item may depend on the rank order of the item (e.g., decaying with lower rank).

A set of items from which recommendations are made is partitioned or otherwise divided into subsets, and jitter is introduced by selection of one subset for each recommendation. For example, a round robin selection of parts of a partition is made for sequential recommendations.

Statistically equivalent sets are constructed based on item characteristics and/or user preferences, and a recommendation is made from a particular set.

Jitter can be introduced to provide variation in sequential recommendations.

Jitter can be introduced according to time, for example, to provide variation from day-to-day but not necessarily within recommendations during a particular day.

Each user may have associated preference parameters associated with different interest modes, and jitter is introduced by selection of the mode. An example of a mode is a “mood.”

Other features and advantages of the invention are apparent from the following description, and from the claims.

### DESCRIPTION OF DRAWINGS

FIG. 1 is a block diagram of a recommendation system.

### DESCRIPTION

### 1 Overview

In some examples of recommendation systems, the system makes a deterministic recommendation of items to a consumer that is generated by relying on system state. For example, the system state includes a characterization of the consumer's preferences and a characterization of the items available for recommendation. If that state is sufficiently stable, the recommendations generated will not vary over time. There are advantages to providing stable recommendations. For example, the predictability of the recommendations provided to the consumer on different instances of using the system can provide a reassurance to the consumer that the system is matching his or her preferences rather than simply guessing. On the other hand, repeatedly providing the same recommendations can have disadvantages as well. For example, the recommendations made to a consumer can become “stale,” in the sense that subsequent repetitions of the same recommendations are not effective. In a commercial system, for example an online retail store, in which recommendations may be provided to motivate the consumer to enter into commercial transactions, the staleness may be manifested in fewer such transactions. In a subscription service, the staleness may be manifested with the consumer not perceiving value in the recommendation service as compared to other ways of locating items that may be of interest. In an ad-supported online service, the staleness may be manifested with fewer clicks on recommendations, resulting in reduced use of the service, fewer page views, and lower ad revenue for the service.

In some examples of recommendation systems, variation in recommendations provided to the consumer is controlled at one, two, or more points in the procedure used to determine recommendations to the user. Generally, the goal of introducing controlled variation is to balance advantages of predictability and stability in recommendations with sufficient variation to achieve overall goals for the system. In general, such intentionally introduced controlled variation or unpredictability in recommendations is referred to in this description as “jitter.”

It is noteworthy that different systems may try to elicit different consumer experiences, and therefore, the selection of appropriate types or degree of jitter may differ for such different systems. As an example, a system that is designed to encourage consumer purchases of items uses different types of jitter than a system that is designed to encourage repeated use of the system, such as a subscription-based music system, for example by providing a perceived value in recommendations. Also, the appropriate types or degree of jitter may vary for a particular consumer over time as they use a system. For example, it may be desirable to provide relatively less jitter to a new user to elicit a degree of confidence in the system and then to increase the degree of jitter progressively as they continue to use the system.

Note that in this description, examples focus on systems that explicitly provide “recommendations.” The techniques described herein are not necessarily limited to these examples, other arenas where jitter can be applied include selection of items to be displayed in advertising, automatic generation of lists of media for presentation (e.g., “playlists”), or any other arena in which a set of items is selected and explicitly or implicitly presented to a consumer. Also, the term “consumer” is used to refer to a user to whom a recommendation is presented. The term “user” or “end-user” may be used in this description where its meaning is evident from context. Also, the term “consumer” should not be construed to require that such a user necessarily purchases the items or enters into other types of commercial transactions involving the recommended items.

A number of different approaches to introducing jitter are described below. These include approaches that induce jitter through configurable deterministic and/or non-deterministic (i.e., “random”) techniques. As introduced above, these approaches can be used independently or multiple approaches can be use together jointly to achieve an appropriate balance between variation and stability of recommendations. In some examples, the recommendation system takes a catalog of recommendable items and, through a series of evaluation steps and reduction steps, reduces the catalog to a recommendation set which is then presented to the consumer. Opportunities for introducing jitter exist in virtually every step of this process, including catalog selection, evaluation, reduction, and presentation.

In general, approaches to introducing jitter include approaches in which jitter is introduced in calculation steps, for example, by randomly perturbing internal coefficients representing underlying properties of the consumer or weighting coefficients for combining component scores to obtain overall item scores. Some approaches introduce jitter in selection steps, for example, in the process of taking a rank-ordered set of items and presenting a random subset to the consumer, or earlier in the process, in selection of a choice set from a number of different choice sets from which a consumer's recommendations are to be made.

In general, in a step in which a mathematical evaluation (e.g., evaluation of an expression or execution of a numerical procedure) is performed, one or more random factors can be included to induce jitter. The random factors can, for example, be used to perturb individual coefficients in the evaluation, or to perturb the result of the evaluation as a whole.

In some examples, fixed variations in algorithms can be chosen at random or in an orderly pattern, for example using different coefficients on different days of the week or cycling through different algorithms. Additionally, the consumer's history can influence the way jitter is introduced. For example, a consumer who receives a few recommendations sporadically can be subjected to less jitter than a user who receives recommendations more frequently.

In general, selection of the approaches for introducing jitter and the degree to which jitter is introduce takes account of a balance between the twin objectives of providing a quality recommendation set and providing a varying recommendation set. Introducing variation has an effect of presenting more recommendation items overall. For example, if a single recommendation set presented P items, and jitter caused J items to be replaced with different items in a subsequent recommendation, then P+J items are presented to the user over the two presentations. If the initial P items were the “best” items for the consumer, then the J additional items would reduce the overall “quality” of the combined recommendation sets. Thus, in such an example J could be selected to be only as large as necessary to give the user a sufficient level of variation.

### 2 Examples

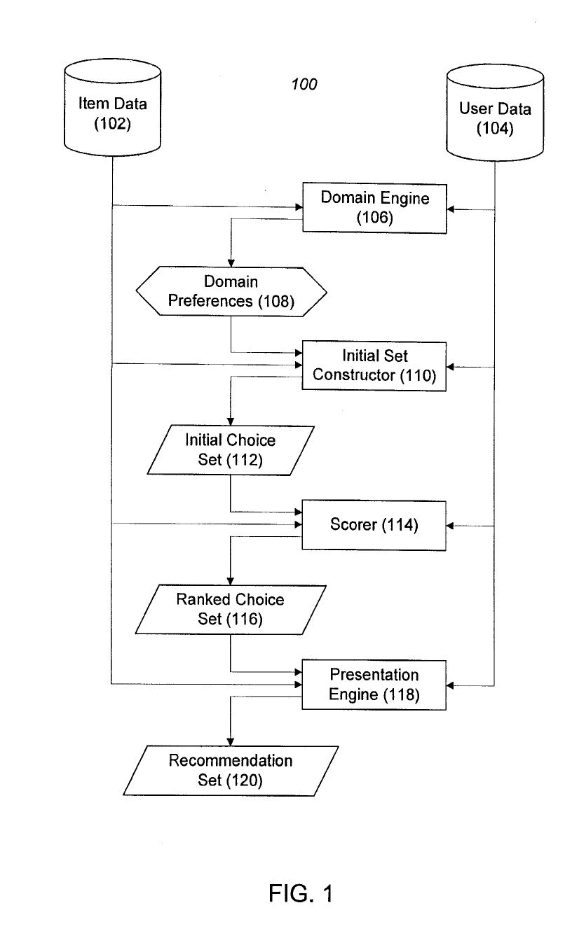

Referring to FIG. 1, an example of a recommendation system 100 incorporates a number of different approaches to introducing jitter in recommendations provided to consumers. In other examples, not all these approaches are necessarily used together and only one, two, or more of these approaches are included.

The system 100 has a catalog of recommendable items 102 and a database of user information 104. In this example, the items in the catalog have been divided into distinct domains grouping similar items together such that items within a domain can be compared to other items in the same domain. An example of a domain in a music recommendation system is a genre of music (e.g., rock, country, etc.). A user's data 104, such as that user's purchase history, reflects the user's domain preferences 108 as assessed by a domain preference engine 106. An initial choice set of items 112 related to the user's past activity within the preferred domain is constructed 110 and then scored 114 according to the likelihood of selection by the user to create a scored choice set 116. A presentation engine 118 selects one or more items from one or more domain specific initial choice sets 116 and presents them to the user as a recommendation set 118. The presentation may be staged in multiple phases with only a subset of the recommendations presented along with an option to see more of the recommendation set.

In this example, jitter is introduced to the recommendation system in several places. A first place that jitter is introduced is in the algorithm or expression used to determine the user's domain preference 106. Domain preference can be determined at least in part based on a quantitative history of the user's activity, for example, indicating a degree of activity that may be associated with a preference for the domain or indicating a time duration since the user's last activity associated with the domain. One example of a jitter factor is random numbers used as coefficients against two such quantitative aspects, altering the weight given to each. Another example is a small random number that is added or subtracted from the score for each domain.

After termination of the domain preferences 108, the system uses an initial choice set constructor 110 to form the initial choice sets 110. This formation of the choice sets may be subject to jitter. In this example, items are added to the initial choice set if they are similar to an item involved in a past history event for the user (e.g., if the user previously selected such an item). In some examples, similarity may include a factor related the time since the event and another factor related to the match between that event and the item being added. An example of a jitter factor is random numbers used as coefficients weighing the relative contribution of these two factors. Another example of jitter in this context involves adding or subtracting a small random number to the match score that is computed (or looked up in a pre-computed table) for items in determining whether to add them to the choice set. In examples in which a pre-computed similarity table is used, the construction of the table presents an opportunity for jitter. The coefficients of each item aspect used in computing similarity may be multiplied by small random numbers altering the weight given each aspect. The table may be modified from time to time to change the jitter factors. Use of the table also presents an opportunity for jitter. An item might have a large number of similar items, but only a few of them might be selected for the initial choice set. This selection could be at random or could follow some rule such as using a predetermined subset for each day of the week or in some other cyclical fashion.

In another example of choice set formation, items are added to an initial choice set based on a set of rules for choosing items from pre-defined or dynamically constructed sub-sets of the catalog. One example might be creating a choice set by choosing from a combination of the most popular items and the most recently added items. Variation can be introduced into this choice set by, for example, modifying the proportion of items from each sub-set and/or random selection of items from each sub-set.

After formation of the choice set or sets, the system applies a scorer 114, for example, to determine a score that is representative of the likelihood of selection by the user (e.g., in applications in which a design goal is high likelihood of selection of a recommended item). The score is determined by an algorithm subject to jitter. For example, a jitter factor might be random numbers used as coefficients against the various factors used to compute the score, altering the weight given to each, or to coefficients used in computing various terms of the score. As a specific example, weighting factors each related to one of a term related to the recency of an item, a popularity of an item, and a match to the user's preferences, are perturbed. As another example, a small random number is added or subtracted from the overall score as well. Through this application of jitter, the specific scores applied to the items in the choice set(s), and possibly as a result the rank ordering of the items based on the scores, may be subject to the random variation.

After formation of the scored and/or rank ordered set of items from the choice set, the system applies a presentation engine 118 to select selecting items from one or more domain specific choice sets. In some examples, this selection process is also subject to jitter. In some examples, the proportion of items taken from each domain may be altered slightly, for example, by multiplication with a small random number. In some examples, items within a domain might be selected at random from a larger number of top scoring items (e.g. randomly selecting five of the top twenty items in a domain). In some examples, items might be selected according to a pattern of rules dictated by the date or time. Items might be selected only if the have not been previously selected in a recent time period. Items might be selected based on the number of times recommendations have been presented to the user within a recent time period. For example, a user who has not received any recommendations in the last 24 hours might receive a set selected more from the user's most preferred domain and more towards the highest scoring items in that domain. A subsequent recommendation set within a 24 hour period might only allow one or two items that have been recommended in the last 24 hours and focus more on including items from a domain in which there was activity in the last 24 hours. Additionally, the order in which the items in the recommendation set are presented may be subject to jitter. Items might, for example, be presented in random order.

### 3 Jitter Variations

In application of jitter at one or more levels, a degree of stability may be configured in the system by limiting how often the jitter factors are changed. For example, in approaches to jitter that involve use of pseudo-random numbers in selection terms, a random seed may be fixed for periods of time, for example, for fixed 30 minute periods, or for a 30 minute duration after each recommendation is made. In this way, a user that requests repeated recommendations will not observe a change based on such random factors on each recommendation.

In some examples, different types of jitter may be configured to have different degrees of stability. For example, the selector of item domains (e.g., music genres) may have a different duration of stability than then selection of the choice sets themselves. As another example, a pre-computed similarity matrix used to form a choice set of items similar to events in the user's history may be recomputed periodically (e.g., once a week) with each re-computation introducing different jitter. Then, the selection from the choice set may be kept stable for durations of, for example, 30 minutes.

Catalog creation has a direct influence on recommendation variation. If the catalog changes on a regular basis, the recommendation set will also change on a regular basis. Less jitter is necessary to achieve a desirable level of recommendation variation when the catalog is frequently and dramatically altered. Jitter becomes more important as the catalog becomes more stable. For example, in an environment where the recommendations are the news stories of the day, the catalog of stories is constantly changing. However, in an environment where the recommendations are classic movies from World War II, the catalog rarely changes and jitter may be more desirable.

An alternative method for introducing jitter to an evaluation step, such as assessing domain preference or item preference, is to use different scoring equations (or coefficients) based on the user's mood. The mood may be guessed at random or predicted based on current session activity, time of day, general recent activity by similar users, or other predictive indicators. Various moods may require the scoring algorithm to place more emphasis on item popularity, domain, seasonality, or some other item attribute.

Reduction steps such as selecting an initial choice set generally rely on scores generated during an evaluation step. Additional jitter can also be introduced into the reduction step, impacting how the scores are used. For example, a reduction step jitter rule might require that the choice set consist of 10 items selected at random from the top 30 items. Here the score is used to determine the top 30 items, but a jitter factor is used in forming the choice set. This could be more carefully tailored to, say, select one item at random from the top 3, one item from the next-best 3, and so forth—ensuring a smooth distribution of quality across the recommendation set.

Approaches described above can be used for a variety of applications involving the selection of items for users. In various examples, items include one or more of: retail items being recommended to a consumer for purchase; media items recommended for reading, viewing, or listening; advertisements or other solicitations; online web pages; and forums or discussions. In general, items can comprise information, subject matter, ideas, goods, media, or other things that can be selected in the manners described.

### 4 Implementations

The techniques and all of the functional operations described in this specification can be implemented in digital electronic circuitry, or in computer hardware, firmware, software, or in combinations of them. The system can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the system can be performed by one or more programmable processors executing a computer program to perform functions of the system by operating on input data and generating output. Method steps can also be performed by, and apparatus of the system can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the system can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. Interaction with a user does not need to be direct. The system can be implemented with an application programming interface allowing alternative means of exchanging input data and output data with the system.

It is to be understood that the foregoing description is intended to illustrate and not to limit the scope of the invention, which is defined by the scope of the appended claims. Other embodiments are within the scope of the following claims.

1. (canceled)

2. The method of claim 13 wherein for each of the plurality of steps, introducing the separate controlled variation into the result of the step includes limiting variation according to a time span.

3. The method of claim 2 wherein limiting variation according to a time span includes maintaining data used to introduce variation, including amending said data at controlled times.

4. The method of claim 3 wherein introducing the separate controlled variation into the result of each of the plurality of steps includes limiting variation according to at least two different time spans, each associated with a different one of the plurality of steps.

5. The method of claim 3 wherein amending said data includes resetting a random seed used for introducing the controlled variation.

6. The method of claim 3 wherein maintaining the data includes maintaining similarity data characterizing similarity of items, and amending said similarity data includes introducing random variations into said similarity data.

7. The method of claim 13 wherein the plurality of steps includes at least one step selected from the group consisting of: selection of item domains; formation of a choice set; assigning a score to items in a choice set; ranking items in a choice set; determining similarity of items; selecting items from a choice set for presentation; and presenting scored and/or ranked items of a choice set.

8. The method of claim 13 wherein introducing a separate controlled variation into a result of each of the plurality of the steps includes at least one of: selecting a choice set; perturbing a term of a numerical expression; offsetting a result of evaluation of a numerical expression; and selecting items from a ranked and/or scored list.

9. The method of claim 13 wherein introducing the controlled variation includes selecting the controlled variation according to data characterizing the one or more users.

10. The method of claim 9 wherein selecting the controlled variation includes selecting said variation according to a history for a user.

11. (canceled)

12. (canceled)

13. A method for repeated selection of items for presentation to a user comprising:
for each repetition of multiple repeated selections of items for presentation to the user,
performing each of a plurality of steps to determine a selection items, including for each step introducing a separate controlled variation into a result of the step, and
determining the items for presentation to the user according to the results of the steps;
wherein the controlled variation for at least one of the steps is fixed for a time interval such that repeatedly performing said step within the time interval includes introducing a same controlled variation at each repetition, and subsequently performing said step outside the time interval includes introducing a different controlled variation.

14. The method of claim 13 wherein the plurality of steps includes
determining preferences of the one or more users based on past activity of the one or more users;
selecting a first set of items from a plurality of items based on the preferences of the one or more users; and
ranking the first set of items based on a predicted likelihood of the one or more users choosing the items.

15. Software stored on non-transitory computer readable media comprising instructions for causing a computing system to repeatedly select items for presentation to a user, the instructions causing the computing system to:
for each repetition of multiple repeated selections of items for presentation to the user,
perform each of a plurality of steps to determine a selection items, including for each step introducing a separate controlled variation into a result of the step, and
determine the items for presentation to the user according to the results of the steps;
wherein the controlled variation for at least one of the steps is fixed for a time interval such that repeatedly performing said step within the time interval includes introducing a same controlled variation at each repetition, and subsequently performing said step outside the time interval includes introducing a different controlled variation.

16. A system for repeated selection of items for presentation to a user comprising:
a selection module configured to repeatedly select items for presentation to the user, the selection module configured to:
perform each of a plurality of steps to determine a selection of items, including for each step introducing a separate controlled variation into a result of the step, and
determine the items for presentation to the user according to the results of the steps;
wherein the controlled variation for at least one of the steps is fixed for a time interval such that repeatedly performing said step within the time interval includes introducing a same controlled variation at each repetition, and subsequently performing said step outside the time interval includes introducing a different controlled variation.
